(19) United States
(12) Patent Application Publication
(10) Pub. No.: US 2005/0017414 A1
(43) Pub. Date: Jan. 27, 2005

(54) Method of forming a three-dimensional structure

(76) Inventor: Boris Aronovich Gurovich, Moscow (RU)

Correspondence Address: WILLIAM COLLARD;COLLARD & ROE, P.C., 1077 NORTHERN BOULEVARD, ROSLYN, NY, 11576, US

(21) Appl. No.: 10/892,583

(22) Filed: Jul. 15, 2004

(30) Foreign Application Priority Data
Jul. 16, 2003 (RU) 2003 121387

(51) Int. Cl. B29C 41/00

(52) U.S. Cl. 264/488

(57) ABSTRACT

A method of forming a three-dimensional structure consisting of plurality of areas with various physical properties includes deposition on a substrate of plurality of layers from a starting material capable of transforming its physical properties under irradiation by accelerated particles beam. In needed cases at least one layer of material is deposited, which is not capable of transforming its physical properties under the influence of specified accelerated particles beam. Simultaneous irradiation in vacuum the plurality of layers by modulated through the mask beam of accelerated particles with the values of energy and radiation dose selected based on determined dependence provides removal of atoms of the first kind and at least partial retaining of atoms of the second kind in starting material of each layer of atoms with modification of material's physical properties in each irradiated area of each layer, which results in forming a three-dimensional structure, composed of plurality of areas with various physical properties.

### FIELD OF THE INVENTION

The present invention can find application in microelectronics for production of integrated circuits for various purposes, as well as for the information storage devices.

### BACKGROUNDS FOR THE INVENTION

Wide application of ion beams for solid state doping by various elements is well known. It allows forming in irradiated materials the secondary phase precipitations with the needed size and density, which determine their physical, chemical and mechanical properties. The specific feature of ion doping is a possibility to dope the material with any (no restriction) element, including those with no solubility in a given material. This feature favored to wide application of the principles of ion modification of structure for control of chemical, physical and mechanical properties.

The method is known for forming a multilayer (three-dimensional) structure, composed of single or several layers 10-100 nm thick (U.S. Pat. No. 6,403,396). This method supposes a forming at the first step of a certain pattern with modified conductivity in 10-100 nm films by optical or accelerated particle influence, which transforms a conductivity in the irradiated areas. Then the obtained layers are got together in a stack to form a three-dimensional structure.

The drawback of such a technology is a necessity in very fine applying of the layers with matching the elements in various layers. The latter represents a rather difficult task, which sometimes limits the element size in a structure. It should be noted that such approach (using the elementary particles or ions) does not envisage a simultaneous processing of multilayer (or single layer˜100 nm thick) structure. The reason is that in such “thick” layers a beam absorption zone in bottom layers (or in a bottom part of a single layer) broadens so much that overlaps with the neighbor one, which is inadmissible. This problem brings to decrease the structure elements density.

The known method does not foresee a revealing of optimal conditions for obtaining the structures with highest possible density of elements (i.e. resolution) and a needed degree of material transformation from insulating to conducting state. In description of patent RU, No 2183882, A1 (the patent-analog U.S. Pat. No. 6,403,396, see last 8 lines in column 31) it was noted that the degree of material transformation from insulating to conducting state (or vice versa) can be controlled by irradiation parameters (dose, intensity, spectrum), but no certain recommendations have been proposed on selection of the optimal parameters.

It should be noted that in neither known patent nor its patents-analogs a simultaneous processing of several layers was envisaged. However, such method can be applied only for optical irradiation as a material transforming tool and for metal-polymeric processing materials with spectral-dependent characteristics as to their properties transformation.

Besides, this method does not permit a noticeable electric conductivity variation in the processed areas since there is no means of polymer destruction products removal.

### SUMMARY OF THE INVENTION

It's a primary object of a present invention to provide simultaneous modification of material's physical properties in irradiated areas of each layer of multilayer structure, which allows forming on a single substrate a three-dimensional structure with areas having various electric, magnetic, optical and other physical properties.

It's another object of the invention to form a three-dimensional structure, composed of irradiated areas with modified physical properties situated in internal layers of the structure.

One more object of a present invention is to form a three-dimensional structure with irradiated areas where the physical properties are modified in a part of a thickness only.

The declared object is achieved by developing a method of forming a three-dimensional structure, composed of plurality of areas with various physical properties, comprising deposition on a substrate of plurality of layers of at least diatomic materials including at least atoms of a first kind and atoms of a second kind, capable of transformation their physical properties under the influence of accelerated particles irradiation with obtaining a three-dimensional structure, which according to the invention is accomplished by arranging a mask with at least one through hole on a way of accelerated particles beam to said three-dimensional structure; determination of physical properties variation dependence for said starting material of each said layer depending on a kind of each said plurality of accelerated particles in said beam, on energy value transferred by each kind of said plurality of accelerated particles at their interaction with said atoms of first and second kinds in irradiation process, and on a thickness of said layer; selection based on said determined dependence of a kind of each accelerated particle of said plurality, of energy value for each kind of said accelerated particles, sufficient for passing through said plurality of layers with formation of beam absorption zone and not less than that needed for moving away from said starting material of each said layer of atoms of first kind and at least partial retaining in said starting material of each said layer of atoms of said second kind with transformation of physical properties of said starting material in each irradiated area of each said layer to obtain the needed physical properties of irradiated material of each said irradiated area in the whole thickness of each said layer; selection based on said determined dependence of radiation dose for each layer of said plurality of layers to retain in said irradiated material of each said irradiated area of part of atoms of second kind, which ensures the needed physical properties in said irradiated material of each said irradiated area; simultaneous irradiation in vacuum of said plurality of layers by modulated through said mask beam of selected accelerated particles with said selected energy value and radiation dose until the obtaining a three-dimensional structure, composed of plurality of areas with various physical properties.

Due to this invention it became possible to modify during a single irradiation process the physical properties in irradiated areas of each layer of a multilayer structure and to form on single substrate a three-dimensional structure with areas having different electric, magnetic, optical and other physical properties, which extends the functional possibilities of the method and raises its production.

According to invention it's advisable to create in said mask placed on a way of said accelerated particle beam to said three-dimensional structure at least one additional through hole, at that a selection based on said determined dependence of energy value for each said accelerated particle is accomplished subject to forming in said three-dimensional structure at least two beam absorption zones without contact with each other.

According to invention it's advisable to discretely change during said irradiation a said radiation dose in a range of the doses selected due to said dependence to provide a uniform profile for physical properties transformation through the hole layer thickness.

Variant of the invention implementation exists wherein in said mask situated on the way of said accelerated particles beam to said three-dimensional structure there is at least one blind hole, at that selection based on said determined dependence of energy value for each said accelerated particle is performed subject to possibility of passing at least a part of said accelerated particles through said blind hole in said mask with formation of additional irradiated area in at least one said layer. That ensures a forming of three-dimensional structure with irradiated areas, where the physical properties are modified in a part of the thickness only.

According to invention it's advisable to perform after formation of said three-dimensional structure, consisting of said plurality of areas with various physical properties a second modulated irradiation in vacuum for at least one earlier irradiated area of said plurality of layers by accelerated particles beam consisting of said atoms of first kind which restores the starting properties of said irradiated area. That allows forming a three-dimensional structure, where the irradiated areas with modified physical properties are located in internal layers of the structure:

According to invention it's advisable to form a three-dimensional structure consisting of said plurality of areas with various physical properties wherein a layer of material (e.g. diamond-like carbon film), which is not capable of transforming its physical properties under the influence of said modulated irradiation, is introduced between at least two said layers.

According to invention it's advisable to use protons or electrons as said accelerated particles.

According to invention it's advisable to use helium ions as said accelerated particles.

According to invention it's advisable to use hydrogen or helium atoms as said accelerated particles According to invention it's advisable to use the atoms of element selected from the group consisting of oxygen, hydrogen, nitrogen, fluorine, carbon as atoms of first kind of said at least diatomic material.

Due to this invention it became possible to ensure an extremely fine matching of the patterns in different layers of a multilayer patterned structure, which excludes a damage of the pattern in underlying layer of the structure and improves quality of products.

### BRIEF DESCRIPTION OF THE DRAWINGS

FIG. 1 is a plot of electric resistivity versus radiation dose for diatomic material.

FIG. 2 is a plot of saturation magnetization versus radiation dose for diatomic material.

FIG. 3 is a variation of number of atoms of the first kind and probably of the second kind versus the depth in three-dimensional structure for various accelerated particle energies (a—low energy, b,c—moderate energy, d—high energy).

FIG. 4 is a starting three-dimensional structure according to the invention (cross-section).

FIG. 5 is a three-dimensional structure formed with a single mask according to the invention (cross-section).

FIG. 6 is a sketch of acceptable arrangement of beam absorption zones in a formed three-dimensional structure according to the invention (cross-section).

FIG. 7 is a sketch of consecutive steps for a three-dimensional structure forming according to the invention using different masks and various accelerated particles.

FIG. 8 is a sketch of consecutive steps for a three-dimensional structure forming according to the invention using a mask with through and blind holes and various accelerated particles.

### DETAILED DESCRIPTION OF THE INVENTION

The herein-proposed method of forming a three-dimensional structure consisting of plurality of areas with various physical properties includes the following steps:

Deposition on a substrate of plurality of layers from a starting material capable of transforming its physical properties under irradiation by accelerated particles. At that as starting material for each layer at least diatomic material is used including at least atoms of a first kind and atoms of a second kind. The atoms of element selected from the group consisting of oxygen, hydrogen, nitrogen, fluorine, and carbon are used as atoms of first kind of said material. As a result a starting three-dimensional structure is obtained.

An accelerated particle beam is created consisting of a plurality of accelerated particles; such as protons, or electrons, or helium ions, or hydrogen atoms, or helium atoms.

On a way of said accelerated particle beam to said starting three-dimensional structure a mask is placed with at least one through hole.

The physical properties variation dependence for said starting material of each said layer is calculated or experimentally determined depending on a kind of each said plurality of accelerated particles in said beam, on energy value transferred by each kind of said plurality of accelerated particles at their interaction with said atoms of first and second kinds in irradiation process, and on a thickness of each said layer.

According to said determined dependence a kind of each accelerated particle of said plurality and energy value for each kind of said accelerated particles, sufficient for passing through said plurality of layers with formation of beam absorption zone, are selected. At that a selected energy of each said accelerated particle should not be less than those needed for moving away from said starting material of each said layer of atoms of first kind and for partial retaining of atoms of said second kind with transformation of physical properties of said starting material in each irradiated area of each said layer to obtain the needed physical properties of irradiated material of each said irradiated area in the whole thickness of each said layer.

Besides, according to said determined dependence a value of radiation dose is selected for said plurality of layers to retain in said irradiated material of each said irradiated area a part of the atoms of second kind, which ensure obtaining the needed physical properties in said irradiated material of each said irradiated area.

Then a simultaneous irradiation in vacuum of said starting three-dimensional structure with said plurality of layers is performed by modulated through said mask beam of selected accelerated particles with said selected energy value and radiation dose until obtaining a three-dimensional structure, composed of plurality of areas with various physical properties.

During said irradiation the said radiation dose is discretely changed in a range of the doses selected due to said dependence to provide a uniform profile for physical properties transformation through the hole layer thickness in irradiated areas.

The invitation foresees a possibility to place on the way of said accelerated particles beam to said three-dimensional structure a mask, which has besides a said through hole at least one more through hole. Using this mask with at least two through hole the selection based on said determined dependence of energy value for each said accelerated particle is performed subject to possibility of forming in said three-dimensional structure at least two beam absorption zones without contact with each other.

The invitation foresees a possibility to place on the way of said accelerated particles beam to said three-dimensional structure a mask, which has besides a said through hole(s) at least one more blind hole. Using: this mask the selection based on said determined dependence of energy value for each said accelerated particle is performed subject to possibility of passing at least a part of said accelerated particles through said blind hole in said mask with formation of additional irradiated area in at least one said layer.

The invention foresees an implementation of the variant of the proposed method when a three-dimensional structure is formed composed of plurality of areas with different physical properties wherein a layer of material (e.g. diamond-like carbon film), which is not capable of transforming its physical properties under the influence of said modulated irradiation, is introduced between at least two said layers.

The invention foresees an implementation of the variant of the proposed method wherein after formation of said three-dimensional structure, consisting of said plurality of areas with various physical properties a second modulated irradiation in vacuum for at least one earlier irradiated area of said plurality of layers by accelerated particle beam consisting of said atoms of first kind which restores the starting properties of said irradiated area.

A said physical properties variation dependence of accelerated particle energies and radiation doses for selected areas of starting three-dimensional structure at a certain pressure in vacuum chamber allows producing three-dimensional structures of high resolution for starting three-dimensional structure with thickness of several hundreds nanometers.

In fact, as experiment shows, with increasing the accelerated particle beam energy the height of a beam absorption zone's narrow part also increases, i.e. a possibility appears to produce structures with higher densities in thicker layers. At the same time a length of projective run of accelerated particles increases too, which allows performing a selective removal of needed atoms in a diatomic material layer of larger thickness. However, there is an upper limit of accelerated particle energy. At very high energies a starting three-dimensional structure can be heated up to melting. On the other hand, the dependent on energy cross-size of a beam absorption zone or its part in processed layer(s) for the used accelerated particle beam should be less than a distance between irradiated areas to exclude a contact of these zones. Otherwise a discontinuity of the formed e.g. conducting areas in insulating matrix would be broken, i.e. the needed patterned conducting structure will not be formed due to electric contacts between the elements.

Thus the demands to the energy value are contradictory to some extent. Moreover this value depends also on a certain diatomic material of a starting layer and on the thickness of the formed structure. It should be noted that the accelerated particle beam parameters and a thickness of given diatomic material layer, which is equal to a length of projective run, are correlated being dependent on diatomic material characteristics also. For example, raising the accelerated particles energy one increases the length of projective run, but the latter parameter depends dramatically on a given material even provided the same particle mass and energy. Of course, to get a selective removal of atoms of certain kind in a most bottom layer a particle should fly through all the structure layers and has enough energy to remove the needed atoms from the whole thickness of the bottom layer. Hence it's reasonable to use the layers with a thickness less than a length of projective run of given particle, a total thickness being less or equal to their length of projective run in a “sandwich”. Low limit of the layer thickness is determined by the need in its continuous nature and/or retaining the individual properties of diatomic material (the latter is problematic for layers thinner than 1-2 nm). Upper limit of a total thickness of “sandwich” and its separate layers depends on certain kind of accelerated particles used for selective removal of atoms, on their energy, on “sandwich” chemical composition and on density of layers.

In particular, for rather thick forming structure (300-700 nmn) the accelerated particle energy should provide a needed length of projective run on the one hand and a needed size of beam absorption zone on the second hand. For thin starting three-dimensional structures (10-50 nm) the situation is possible when even at low particle energy an acceptable size of beam absorption zone in the processed layer can be obtained but this energy could not be enough to remove the needed kind of atoms for modifying the conductivity. This condition should be taken into account at the energy value selection.

At the same time it can turn out that for “thick” starting structures the particle energy needed for flying through all the layers is so high that besides atoms to be removed there will be a partial displacement and removal of the atoms of another kind. As a result the needed physical properties will not be obtained in irradiated areas. For example, if the oxygen atoms should be removed from the copper oxide layer of the starting three-dimensional structure but due to high particle energy the copper atoms start to remove also, the copper atoms concentration in irradiated areas could decrease inadmissibly. This example demonstrates an importance of the radiation dose selection needed for irradiation.

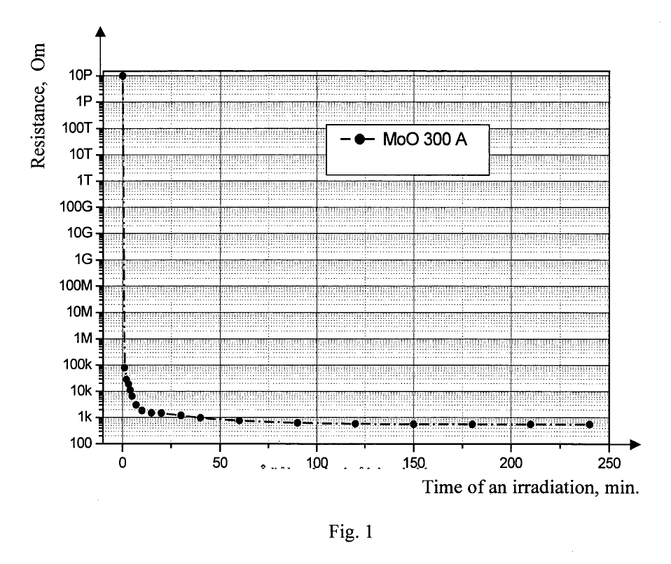

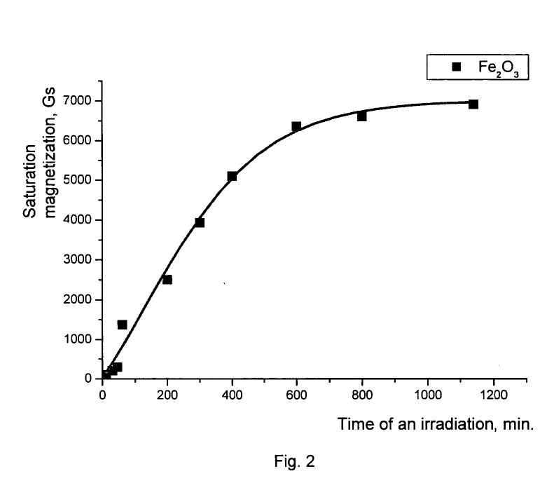

Thus the optimal radiation dose is a minimum value, which is enough to provide a needed modification of physical properties, i.e. an attainment of the needed material parameters, e.g. a needed resistivity for the formed conductor, or desired values of saturation magnetization or coercivity for the formed magnetic bits. Hence to make a decision concerning a choice of radiation dose for each certain task it's necessary to investigate preliminary a dependence of, say, electric resistivity of the irradiated diatomic material versus the radiation dose (FIG. 1), or dependence of saturation magnetization versus the radiation dose (FIG. 2).

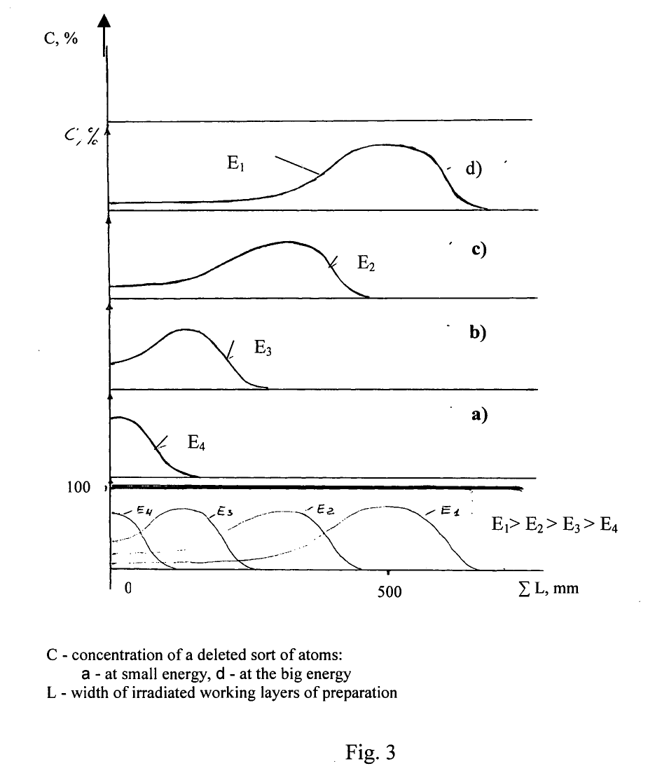

It should be also taken into account that with increase of irradiated layers thickness and accelerated particle energy a “damage profile” of the starting three-dimensional structure (i.e. a displacement rate of atoms at various depths) becomes not uniform, which results in inhomogeneous variation of chemical composition (i.e. of physical properties of diatomic composition) in the process of selective removal of the needed kind of atoms. To get a homogeneous chemical composition of the irradiated area in the whole thickness in needed time duration it's necessary to discretely change the energy of accelerated particles according to a certain dependence, which provides a homogeneous “damage profile” over the whole structure thickness. This implies a preliminary experimental determination of the concentration profile for the removed kind of atoms versus the energy of accelerated particle. Several methods can be used including analytical transmission electron microscopy (to plot concentration profiles at cross-cuts of the irradiated sample), X-ray photoelectronic spectroscopy or secondary ion mass-spectroscopy (layer-by-layer analysis of irradiated sample composition). These measurements allow determining the energy dependence of atomic concentrations for atoms of the first (and probably of second) kind removed during irradiation by accelerated particles (FIG. 3).

When the structure formation is performed by irradiation of starting multilayer structure with accelerated particles beam through a single mask the layers are produced with perfectly matched similar pattern but with different physical properties. If such starting multilayer structure is irradiated through one mask with formation of, say, metallic areas and after that it's irradiated through another mask by another kind of particles, capable of chemical reaction with irradiated material in some areas of upper “sandwich” layers, then it's possible to restore the insulating properties in the corresponding areas. Repeated procedures of this kind allow producing a three-dimensional patterned structure with different patterns and physical properties in various layers.

Repeated irradiations of a starting multilayer structure by accelerated ions or atoms of various kinds (e.g. protons and oxygen ions) through a single mask with a pattern composed of through and blind (of various depths) holes make it possible to produce different patterns (e.g. wirings) in various layers and/or interlayer interconnections. Thereby a problem of pattern matching in various layers of three-dimensional patterned structure can be solved. It should be emphasized that in all the known technical approaches several separate masks are used for this task (one for each layer).

In fact, if a plate of variable thickness is placed between accelerated particle source and irradiated starting three-dimensional structure then the local intensity of the accelerated particle beam at the irradiated structure will depend on the local thickness of the plate. As a result, there will be different penetration depth of corresponding beam into irradiated structure and correspondingly a different thickness of material modified from dielectric into conducting state in irradiated layers of the structure. Thus the “metallization depth” in irradiated areas will depend on the depth of the blind hole of the mask over this area.

Two problems can be solved by use of through holes in the mask. First, a through hole allows getting a larger “metallization depth” as compared to blind one. Second, practically full penetration of accelerated particle beam through those holes makes it possible to restore dielectric properties in the areas of irradiated structure under the holes, which opens additional possibilities for forming patterned conducting or other structures. Moreover, varying the accelerated particle beam parameters and diatomic materials it's possible to form through those holes a multilayer structure (e.g. metal-insulator-metal-insulator-semiconductor-magnetic material-nonmagnetic material).

To keep in a formed patterned structure the areas with starting physical properties a mask thickness should be large enough to completely absorb the accelerated particles in those areas. It means this thickness should be more than the length of projective run of the used accelerated particle in the material of the mask.

Irradiation by accelerated particle beam provides a modification of electric properties of starting three-dimensional structure through its transformation from insulating to semiconducting or metallic state as result of chemical composition variation of diatomic material during its interaction with accelerated particles.

It was experimentally demonstrated that accelerated beams of electrons, protons, helium ions, as well as hydrogen and helium atoms could be used for modification of electric properties of starting three-dimensional structure.

Materials for the layers of starting three-dimensional structure can be selected from a list of known semiconductors or insulators, which are the compositions of various chemical elements with oxygen, hydrogen, nitrogen, fluorine, carbon or their combinations. Under the irradiation by accelerated particles the chemical composition of the listed material changes due to selective removal of nonmetallic atoms (oxygen, hydrogen, nitrogen, fluorine, carbon) from those areas. If organic compositions (hydrocarbons, elementoorganics) are used as said starting material, the hydrogen or oxygen atoms (or their combinations) can be removed by accelerated particles. For example, after the removal of oxygen, hydrogen and carbon from the starting metal-organic material only metal atoms remain in irradiated areas. Similarly, only carbon atoms remain in irradiated areas of hydrocarbon after selective removal of oxygen and hydrogen.

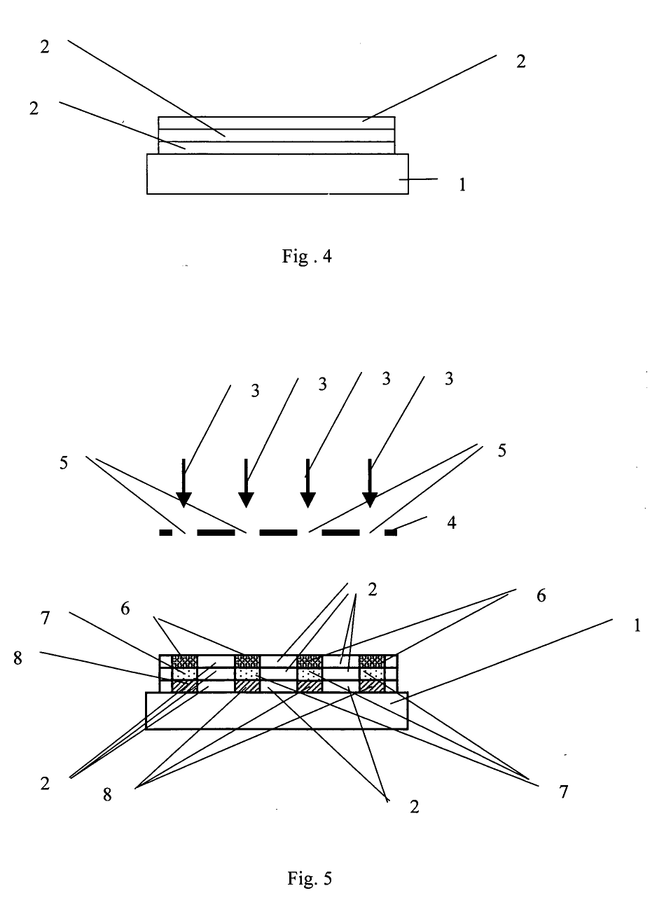

In general case the proposed method of forming three-dimensional patterned structure composed of several steps. Several layers (item 2 in FIG. 4) of the same or different di- or multiatomic materials are deposited on substrate (1) made of silicon single- or polycrystal, aluminium or silicon dioxide. As these starting materials the compositions of metals with oxygen, hydrogen, nitrogen, fluorine, and carbon (or their combination) are mainly used. The obtained starting three-dimensional structures are placed in a vacuum chamber with accelerated particle source, which pumped up to the vacuum 10⁻²-10⁻⁷ Pa. The electrons, protons, helium ions, as well as hydrogen or helium atoms can be used as accelerated particles.

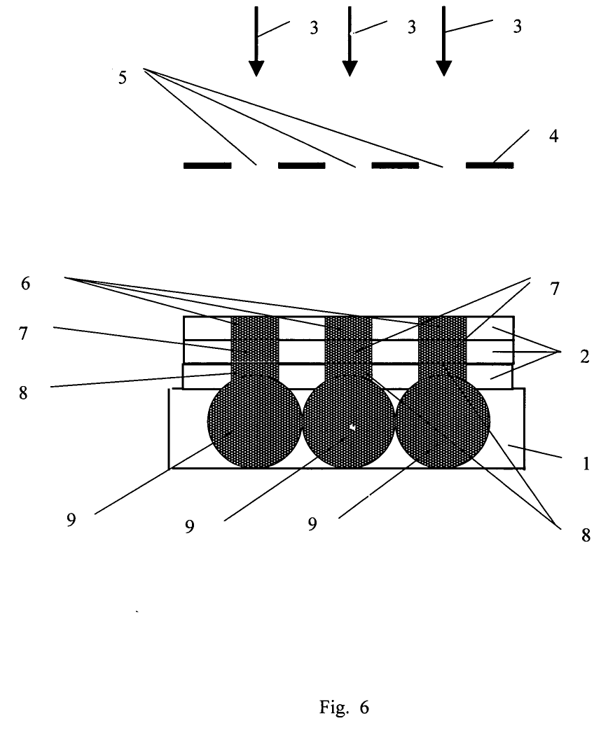

The starting three-dimensional structure is irradiated by accelerated particle beam (item 3 in FIG. 5) with preliminarily determined energy value through the template (mask, 4) having through holes (5). This template (mask) can be placed directly on starting three-dimensional structure, i.e. in contact with upper layer of irradiated structure, or at some distance from it. Under the influence of accelerated particles (3) a modification of starting material's physical properties takes place in irradiated areas of several layers (6,7,8), e.g. transformation of insulator into semiconductor or metal, nonmagnetic material into magnetic one, variation of optical properties, due to selective removal of atoms of the first kind (oxygen, hydrogen, nitrogen, fluorine, and carbon) and at least partial retaining atoms of the second kind (metal) in these areas. As a result a patterned three-dimensional structure is formed, where the patterns in various layers have physical properties other than the surrounding matrix.

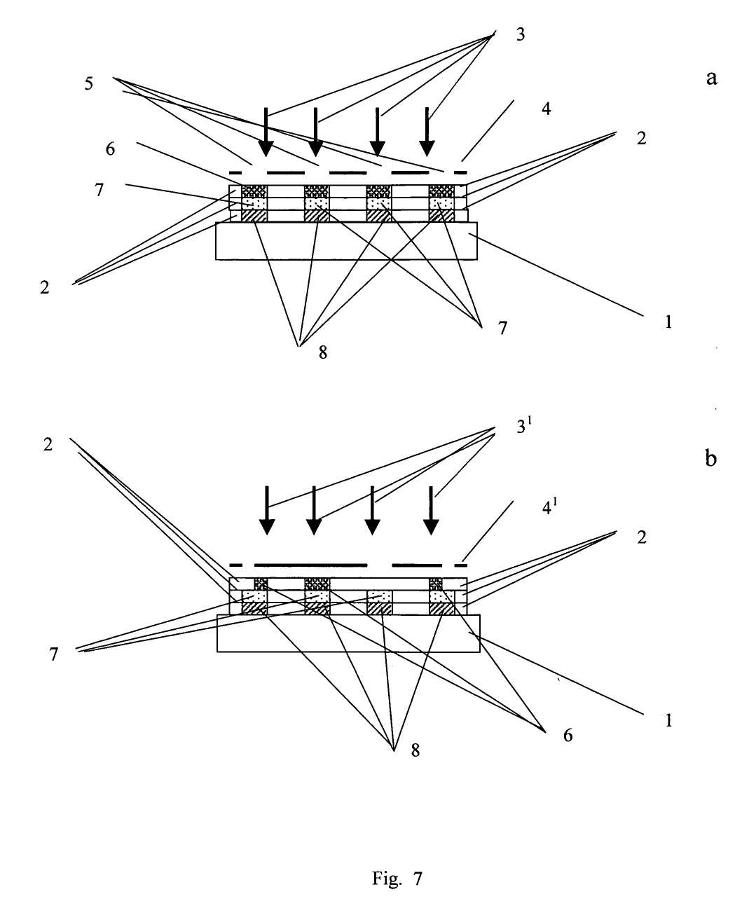

The range of accelerated particles energies needed for forming three-dimensional patterned structure with given parameters (number of layers, a total thickness of the structure, density of structural elements, etc.) are determined from the dependence previously obtained by calculations or measurements. In the first case a size and shape of beam absorption zone (item 9 in FIG. 6) in irradiated areas of the layers is calculated on the basis of reference data and theoretical models. Then the portions of removed light atoms (atoms of the first kind) and of removed heavy atoms (atoms of the second kind) are calculated, the latter being important at higher energies. A selected energy should prevent contacting of neighbor beam absorption zones and retain a reasonable amount of atoms of the second kind in the irradiated areas. The latter is important; otherwise the irradiated areas could not demonstrate the needed physical properties.

As shown in FIG. 6, in perfect case only narrow part of a beam absorption zone (9) is located in the modified layers, its broad part being located in the substrate. In this case even direct contact between neighbor beam absorption zones is admissible since it doesn't influence a resolution of the formed structure.

In case of small thickness of processed layers of the formed structure and small cross-size of beam absorption zone (9) the energy value of accelerated particles is calculated, which is sufficient for providing both selective removal of atoms of the first kind (i.e. a needed modification of the starting properties) and a length of projective run exceeding the total thickness of all the layers in starting three-dimensional structure.

If the experimental approach to accelerated particle energy determination needed for forming a three-dimensional patterned structure is selected then several preliminary experiments are performed. The starting three-dimensional structures with needed number of layers of various materials are irradiated through the mask by accelerated particle beam with varied energy and a dependence of resistivity of irradiated diatomic material is measured versus radiation dose (it can be also a dependence of saturation magnetization of irradiated diatomic material versus radiation dose), as shown in FIG. 1 and FIG. 2.

The procedure is as follows. A layer of starting material is deposited on substrate and irradiated by a certain radiation dose. Then the physical properties of irradiated material are measured. After that the same procedure is repeated with another value of radiation dose. For example it can be resistivity of starting metal oxide. It's obvious that with increasing radiation dose more oxygen atoms will be removed, which results in electric conductivity increase. For prescribed value of the resistivity of forming conductive area in dielectric matrix a needed radiation dose is selected due to the measured dependence. Similarly, the analogous dose dependencies for magnetic, optical and other properties can be investigated.

Relying on obtained dose dependencies of physical properties of irradiated diatomic material the radiation dose is selected, which is needed to get a given values of physical properties. Then the irradiated structures are studied to define a size and shape of beam absorption zones. Finally the energy value is selected, which provides the given geometrical parameters of the formed structure.

In some cases it's reasonable to use both calculations and measurements to find the optimal value of accelerated particle energy needed for the method implementation. At the first stage this value is approximately calculated and then it's defined more accurately during the measurements. This combined approach allows saving time and resources in selection of accelerated particles kind and energy for implementation of technological process of forming a three-dimensional structure.

An irradiation of starting three-dimensional structure can be performed with a single or several masks with through holes only or by scanning with intensity modulated beam of accelerated particles over the surface of starting three-dimensional structure. With a single mask both procedures give the same pattern (topology) in all the layers.

According the invention the said method can be used in a multiple irradiation variant. In this case the first irradiation of the layers (item “a” in FIG. 7) in starting three-dimensional structure is performed through the first mask (4) and the second irradiation is performed through the second mask (4¹), at that the second irradiation uses accelerated particles beam (3¹); providing a restoration of starting properties in the repeatedly irradiated areas of the upper layer of the structure.

According to invention the said method can be used with a mask having both through holes and blind holes of various depths. In this case a three-dimensional conducting structure is produced in a following manner.

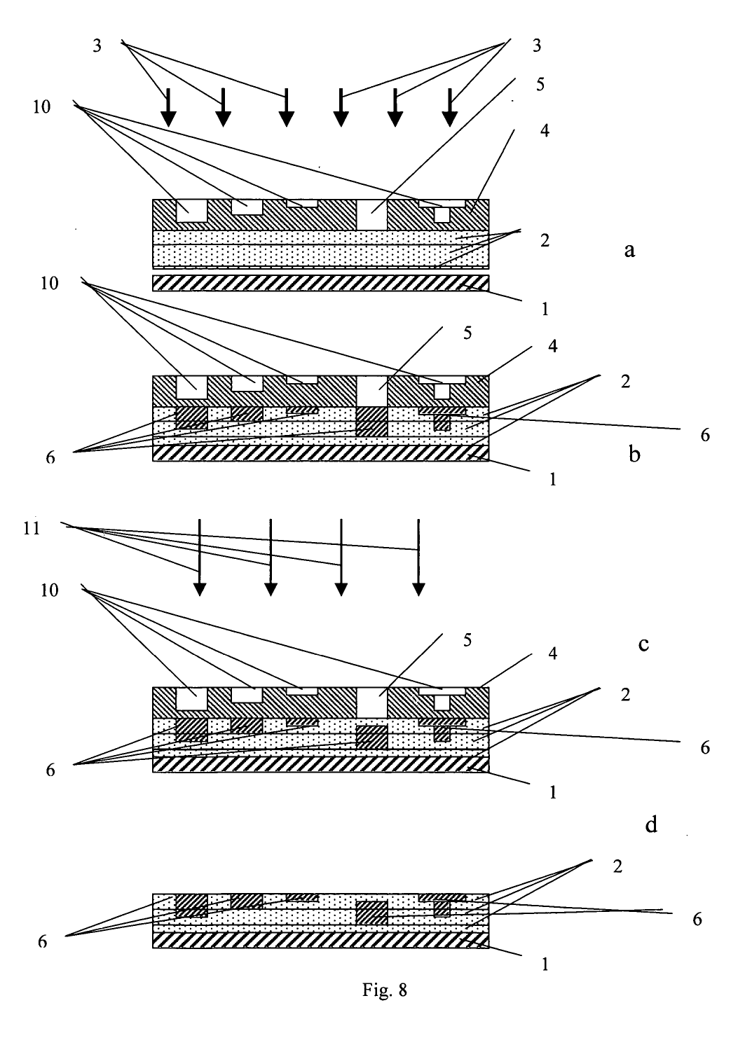

Several layers (2) of diatomic material of the needed thickness are deposited on substrate (1) (item “a” in FIG. 8) made of silicon, aluminium or silicon dioxide. As these starting materials the compositions of metals with oxygen, hydrogen, nitrogen, fluorine, and carbon (or their combination) are mainly used.

The obtained staring three-dimensional structure is irradiated by accelerated particles beam (3). The protons, helium ions, as well as hydrogen or helium atoms can be used as accelerated particles. The irradiation is performed through the mask (4) placed directly on the surface of the structure. According to given pattern the mask (4) has a number of through holes (5) and blind holes (10) of various depths.

Under the influence of accelerated particles beam (3) a modification of starting insulating properties into semiconducting or metallic ones is performed due to selective removal of non-metal atoms from irradiated areas (6). The depth of properties modification in the layers (2) of starting structure depends on blind holes (10) depth, as shown in FIG. 7 “b”.

After first irradiation by accelerated particles (3) the second irradiation is performed through the same mask (4) by ion beam (11), which restores the starting properties in the upper layers of the structure, as shown in FIG. 8 “c”. Not only ions of the removed atoms but also ions of other kind can be used in this process. For example, the nitrogen atoms are removed from aluminium, copper or gallium nitride layers under irradiation by accelerated particles, but the corresponding restoration of insulating properties can be obtained by oxygen ions irradiation. Sometimes it's just enough to take the structure with the mask off the vacuum chamber and leave it in air. High enough chemical activity of the metal in irradiated areas ensures a restoration of the starting insulating properties (e.g. it occurs for aluminium, which transforms very fast in insulating aluminium oxide).

After completing the process of the structure forming the mask (4) is removed by traditional way (mechanical releasing, chemical or reactive ion etching) as shown in FIG. 8 “d”. Thus with a single mask it's possible to form a three-dimensional conducting (or other) multilayer structure with different topologies and physical properties in various layers.

There is one more version of the proposed method, which is similar to that described earlier as to vacuum in the camera, selection of energy value and radiation dose of accelerated particles, but it uses several different masks with through holes for forming a three-dimensional structure. In the beginning a starting three-dimensional structure is irradiated by accelerated particle beam, which forms similar patterns in all the layers. Then another mask is placed over the structure or directly on its surface, some holes in this mask matching the irradiated areas (where the material's properties were modified by the first irradiation). The second irradiation is performed by accelerated particles (ions of removed atoms—oxygen, nitrogen, fluorine, hydrogen—or other), which restore the starting chemical composition and starting insulating properties in the layers, where those ions penetrate. In this case a forming of three-dimensional structure with different patterns and properties in various layers is also possible. But this approach implies the use of several masks for forming one structure, which leads to technological problems with necessity of fine positioning of various masks over the irradiated structure.

Thus the proposed invention provides a possibility of simultaneous modification of physical properties in irradiated areas of each layer of multilayer structure with forming on a single substrate a three-dimensional structure with areas different in electric, magnetic, and optical or other physical properties. It's possible to form three-dimensional structures, where irradiated areas with modified physical properties are situated in the internal layers of the structure and/or the structures with physical properties modified in only part of the thickness of irradiated areas.

### EXAMPLE 1

Several layers are deposited on single-crystal substrate 5×5×0.4 mm: the bottom (contacted with substrate) layer from cobalt oxide 50 nm thick, the middle layer of iron oxide 100 nm thick and upper layer of copper oxide 50 mn thick. The obtained starting three-dimensional structure is placed in vacuum chamber with a source of electrons and the chamber is pumped up to the vacuum 5×10⁻⁷ Pa. The irradiation is performed by accelerated particles with preliminarily defined value of energy through the template (mask) with through holes. The mask is placed directly on the upper layer of the starting three-dimensional structure (in special cases the mask can be placed over the structure at some distance). Under the influence of accelerated particle beam a modification of starting properties of the layers in irradiated areas is performed (insulating to metallic, nonmagnetic to magnetic, variation of optical properties) due to selective removal of oxygen atoms from the layers materials, i.e. a three-dimensional patterned structure is produced, where the pattern in each layer has the physical properties other than the surrounding matrix.

A range of energy values needed for implementation of technological process of forming a three-dimensional patterned structure with given parameters (number of layers, total thickness, density of structural elements, etc.) is determined according to previously defined dependence of physical properties of diatomic material of each layer on the kind of each of plurality of accelerated particles in the beam, on the energy value passed by each accelerated particle at its interaction with atoms of diatomic material during irradiation, and on the thickness of each layer of the structure. Furthermore, relying on reference data and theoretical models the size and shape of beam absorption zone in irradiated layers, a portion of removed light atoms (oxygen in our case), and a portion of removed heavy metal atoms are calculated. A selected energy value (7 keV) allows avoiding contacts between neighbor beam absorption zones and retaining reasonable amount of metal atoms in irradiated areas. As a result the oxides in all three layers are modified to metals.

### EXAMPLES 2-24

The method is carried out with the same procedure as described earlier with protons as accelerated particles for irradiation of starting three-dimensional structure. Several substrates (5'5×0.4 mm) of single-crystal silicon with preliminary deposited layers of the needed thickness are placed on a holder in vacuum chamber of technological setup. The vacuum chamber is pumped by backing, turbomolecular and finally by ion pump up to the vacuum 10⁻⁷ Pa.

As proton source any known device can be used, e.g. the radio frequency one. The mask is placed on the proton beam way, which prepared from usual resist 0.4 mm thick according to known technology with a pattern appearing as rows of holes 100 nm in diameter and various depths and of through lines each being 100 nm wide and 0.5 mm long spaced 300 nm apart from one another.

After the needed vacuum is obtained the proton source is switched on and its working regime is established providing the modification of insulating properties of materials of the starting three-dimensional structure into semiconducting or metallic properties. The regime for each type of material and its layer thickness are adjusted experimentally. Table 1 demonstrates some of parameters providing the needed result.

TABLE 1

| Number of | Diatomic | Layer thickness, | Proton beam | Average proton |
|---|---|---|---|---|
| example | material | nm | current, mA | energy, keV |
| 2 | Cu₂O | 30 | 1000 | 0.8 |
| 3 | ″ | 20 | 1000 | 0.8 |
| 4 | ″ | 100 | 3000 | 1.5 |
| 5 | ″ | 300 | 3000 | 5 |
| 6 | GeO₂ | 10 | 1000 | 0.9 |
| 7 | ″ | 20 | 1000 | 0.9 |
| 8 | ″ | 100 | 2000 | 1.5 |
| 9 | GaN | 10 | 3000 | 0.5 |
| 10 | ″ | 20 | 5000 | 0.6 |
| 11 | ″ | 100 | 2000 | 1.5 |
| 12 | CaF₂ | 10 | 9000 | 0.5 |
| 13 | ″ | 20 | 8000 | 0.5 |
| 14 | ″ | 100 | 9000 | 1.5 |
| 15 | WO₃ | 10 | 3000 | 0.8 |
| 16 | ″ | 30 | 5000 | 1.4 |
| 17 | ″ | 70 | 8000 | 1.6 |
| 18 | ″ | 500 | 8000 | 30 |
| 19 | AIN | 10 | 3000 | 0.7 |
| 20 | ″ | 50 | 6000 | 1 |
| 21 | ″ | 100 | 9000 | 1.5 |
| 22 | Co₃O₄ | 20 | 3000 | 0.7 |
| 23 | ″ | 50 | 6000 | 1.5 |
| 24 | ″ | 600 | 9000 | 30 |

In some case (e.g. No 19) after completing the proton irradiation the layer is processed by accelerated ion beam for restoration of previously modified properties (usually nitrogen ions are used for this task, but sometimes oxygen ions can be also used).

### EXAMPLES 25

A bottom layer of lanthanum hydrate 50 nm thick and an upper layer of silicon dioxide 10 nm thick are deposited by magnetron sputtering on substrates (5×5×0.4 mm) from single-crystal silicon. The values of threshold displacement energies needed for selective removal of hydrogen and oxygen from said layers are experimentally determined.

Electrons are used as accelerated particles being produced by electron gun with accelerating voltage regulated in a range 40-200 keV. The formation of metallic lanthanum is registered by several methods including a form of diffraction pattern and dose dependence of resistivity (achievement of the value typical or close to that for metallic lanthanum).

In the range of energies of 40-80 keV a removal of hydrogen from lanthanum hydride is not observed. The removal of oxygen from silicon dioxide is detected by origin of the lines characteristic of silicon in the spectra of electron energy loses. It should be noted that in the range of electron energies 40-120 keV the removal of oxygen from silicon dioxide (i.e. its transformation into silicon) is not observed.

Relying on the obtained experimental data an electron beam with energy 200 keV (irradiation time is 3 hours) is used to obtain the similar patterns of lanthanum and silicon in the irradiated layers. These parameters provide a total transformation of the materials in both layers without unwanted physical dispersion of the upper layer.

### EXAMPLES 26

A bottom layer of copper oxide 40 nm thick, a separating (insulating) layer of silicon dioxide 10 nm thick, a cobalt oxide (Co₃O₄) layer 40 nm thick, and upper protecting layer of diamond-like carbon film 10 nm thick are deposited by magnetron sputtering on substrates (5×5×0.4 mm) from single-crystal silicon.

Relying on determined correlations between radiation dose and magnetic properties of irradiated cobalt oxide it's found that the acceptable magnetic properties appear at the dose 5×10¹⁸ ions/cm². A dose dependence of copper oxide resistivity shows a rather high conductivity at this very dose, the acceptable size of beam absorption zone being formed at proton energy of 1.5 keV. The formed structure is irradiated through a single mask with given pattern by proton beam with energy 1.5 keV during 90 min.

As a result the irradiated areas of copper oxide are transformed into metallic copper due to selective removal of oxygen atoms, i.e. their starting insulating properties modify into conducting ones. At the same time the irradiated areas of cobalt oxide are transformed practically completely into metal due to selective removal of oxygen atoms, i.e. their starting nonmagnetic properties modify into ferromagnetic ones. In this case irradiation through a single mask produces the same patterns (conducting and magnetic) in both layers with their perfect matching one over another. The proton beam with selected parameters doesn't change the properties of insulating and protecting layers of diamond-like carbon film.

### EXAMPLES 27

A bottom layer of cobalt oxide (Co₃O₄) 40 nm thick and upper layer of nickel oxide 50 nm thick are deposited on substrate from single-crystal silicon. This starting structure is irradiated by proton beam with energy 2.5 keV during 2 hours through a mask with through holes. The energy value and radiation dose are determined as in Example 26.

Selective removal of oxygen atoms is carried out in irradiated areas, which results in practically complete transformation of cobalt oxide into metallic cobalt, i.e. its starting insulating nonmagnetic properties modify into metallic ferromagnetic ones. In the upper layer nickel oxide transforms into pure nickel under irradiation with raising its optical transparency and with noticeable variation its refraction index.

### EXAMPLES 28

The method is carried out as in the Examples above. A bottom tungsten oxide (WO₃) layer 10 nm thick and an upper protective layer from diamond-like carbon film 5 nm thick are deposited on a substrate from single-crystal silicon. The formed structure is irradiated during 15 min by accelerated helium atoms beam obtained in result of electron neutralization of helium ion beam with energy 2 keV. After this procedure the tungsten oxide layer in irradiated areas transforms into metallic tungsten due to selective removal of oxygen atoms. The selected irradiation parameters don't lead to noticeable variation of physical properties of protective diamond-like carbon film. Thus the metallic pattern is formed in insulating matrix.

### EXAMPLES 29

The method is carried out as in the Examples above. Protons are used as accelerated particles for irradiation a starting three-dimensional structure. A tungsten oxide layer 500 nm thick is deposited on several substrates (5×5×0.4 mm), which are placed in a holder inside a vacuum chamber of technological setup. The chamber is pumped by backing pump, then by turbomolecular, and finally by ion pump up to the vacuum 10⁻⁷ Pa. Any of known proton source is used, e.g. the radio frequency one. A mask prepared by photolithography is placed on a way of proton beam to the starting structure.

After the needed vacuum is achieved the proton source is switched on and its working regime is established, providing the transformation of starting insulating properties into semiconducting or metallic. Relying on the preliminary experiments the starting structure is irradiated by proton beam in several steps. First it's irradiated by protons with energy 2.5 keV during 35 min, then by 20 keV protons during 10 min, and finally by 30 keV protons during 5 min.

The formed structure is studied layer by layer by X-ray photoelectron spectroscopy. The results show that the modification of the starting chemical composition in the structure is practically homogeneous over the whole thickness.

### EXAMPLES 30

The method is carried out as in the Examples above. A bottom layer, of lanthanum hydride (LaH₂) 120 nm thick, a cobalt oxide (Co₂O₃) layer 30 nm thick, a calcium fluorine (CaF₂) layer 10 nm thick, a gallium nitride (GaN) layer 20 nm thick, a germanium oxide (GeO₂) layer 50 nm thick and upper layer of indium oxide (In₂O₃) 100 nm thick are consecutively deposited by magnetron sputtering on substrates (5×5×0.4 mm) from single-crystal silicon. Relying on previous calculations and preliminary experiments it's established that the proton beam with energy 7 keV is optimal for forming a patterned structure with a maximum elements resolution in the starting structure.

After irradiation during 3 hours in the irradiated areas (under the through holes in a mask) a selective removal of light atoms (hydrogen, oxygen, fluorine, and nitrogen) and a corresponding modification of properties are carried out. After that another mask is placed over the structure, part of its through holes being located just over the areas with modified properties. The structure is irradiated with nitrogen ion beam. During this second irradiation the modification of pure indium in upper layer is performed into indium nitride with back transformation of the properties (from metallic to insulating). The obtained structure has different conducting patterns in various layers.

### EXAMPLES 31

The method is carried out as in the Example 30 with the sole exception that after the final irradiation by accelerated nitrogen ion beam a photoresist layer is applied over the upper indium nitride layer. Then the windows for air access are photolithographycally opened in the needed places of photoresist layer. The metallic indium transforms into indium oxide under these windows. Thus a back transformation of corresponding metallic areas (opened to air) into insulating ones is performed.

### EXAMPLES 32

The method is carried out as in the Examples above with the sole exception that the processed layer composed of hydrocarbon material—lavsan. The starting structure is irradiated by proton beam with energy 1.5 keV during 30 min. After irradiation the hydrogen and oxygen atoms are removed from irradiated areas, only carbon being kept at the substrate, which leads to a noticeable nigrescence of the material in irradiated areas.

1. A method of forming a three-dimensional structure consisting of plurality of areas with various physical properties, said method comprises:
deposition on a substrate of plurality of layers with obtaining a three-dimensional structure;
producing of each of the said plurality of layers from a starting material capable of transforming its physical properties under irradiation;
using as each said starting material at least diatomic material including at least atoms of a first kind and atoms of a second kind;
setting up an accelerated particle beam consisting of a plurality of accelerated particles;
arranging of a mask with at least one through hole on a way of said accelerated particle beam to said three-dimensional structure;
determination of physical properties variation dependence for said starting material of each said layer depending on a kind of each said plurality of accelerated particles in said beam, on energy value transferred by each kind of said plurality of accelerated particles at their interaction with said atoms of first and second kinds in irradiation process, and on a thickness of each said layer;
selection based on said determined dependence of a kind of each accelerated particle of said plurality, energy value for each kind of said accelerated particle, sufficient for passing through said plurality of layers with formation of beam absorption zone and not less than the energy value needed for moving away from said starting material of each said layer of atoms of first kind and at least partial retaining of atoms of said second kind with transformation of physical properties of said starting material in each irradiated area of each said layer to obtain the needed physical properties of irradiated material of each said irradiated area in the whole thickness of each said layer;
selection based on said determined dependence of radiation dose for each layer of said plurality of layers to retain in said irradiated material of each said irradiated area of part of atoms of second kind, which ensures the needed physical properties in said irradiated material of each said irradiated area;
simultaneous irradiation in vacuum of said plurality of layers by modulated through said mask beam of selected accelerated particles with said selected energy value and radiation dose until the obtaining a three-dimensional structure, composed of plurality of areas with various physical properties.

2. The method of forming a three-dimensional structure consisting of plurality of areas with various physical properties of claim 1, wherein in said mask situated on the way of said accelerated particles beam to said three-dimensional structure there is at least one additional through hole, at that selection based on said determined dependence of energy value for each said accelerated particle is performed subject to formation in said three-dimensional structure at least two beam absorption zones without contact with each other.

3. The method of forming a three-dimensional structure consisting of plurality of areas with various physical properties of claim 1, wherein during said irradiation the said radiation dose is discretely changed in a range of the said doses selected according to said dependence.

4. The method of forming a three-dimensional structure consisting of plurality of areas with various physical properties of claim 1, wherein in said mask situated on the way of said accelerated particles beam to said three-dimensional structure there is at least one blind hole, at that selection based on said determined dependence of energy value for each said selected accelerated particle is performed subject to possibility of passing at least a part of said accelerated particles through said blind hole in said mask with formation of additional irradiated area in at least one said layer.

5. The method of forming a three-dimensional structure consisting of plurality of areas with various physical properties of claim 1, wherein after formation of said three-dimensional structure, consisting of said plurality of areas with various physical properties a second modulated irradiation in vacuum is performed for at least one earlier irradiated area of said plurality of layers by a beam of atoms of first kind used as said accelerated particles, for restoration the starting properties of said irradiated area.

6. The method of forming a three-dimensional structure consisting of plurality of areas with various physical properties of claim 4, wherein after formation of said three-dimensional structure, consisting of said plurality of areas with various physical properties a second modulated irradiation in vacuum is performed for at least one earlier irradiated area of said plurality of layers by a beam of atoms of first kind used as said accelerated particles, for restoration the starting properties of said irradiated area.

7. The method of forming a three-dimensional structure consisting of plurality of areas with various physical properties of claim 1, wherein a layer of material, which is not capable of transforming its physical properties under the influence of said modulated irradiation, is introduced between at least two said layers

8. The method of forming a three-dimensional structure consisting of plurality of areas with various physical properties of claim 1, wherein protons or electrons are used as said accelerated particles.

9. The method of forming a three-dimensional structure consisting of plurality of areas with various physical properties of claim 1, wherein helium ions are used as said accelerated particles.

10. The method of forming a three-dimensional structure consisting of plurality of areas with various physical properties of claim 1, wherein hydrogen or helium atoms are used as said accelerated particles.

11. The method of forming a three-dimensional structure consisting of plurality of areas with various physical properties of claim 1, wherein the atoms of element selected from the group consisting of oxygen, hydrogen, nitrogen, fluorine, carbon are used as atoms of first kind of said at least diatomic material.
